(19) United States
(12) Patent Application Publication
(10) Pub. No.: US 2010/0220575 A1
(43) Pub. Date: Sep. 2, 2010

(54) OPTICAL PICKUP HEAD

(75) Inventors: Wen-Hsin Sun, Taoyuan (TW); Mao-Jen Wu, Taoyuan (TW); Hsiao-Chin Lan, Taoyuan (TW); An-Nong Wen, Taoyuan (TW); Chih-Hung Hsu, Taoyuan (TW)

Correspondence Address: KIRTON AND MCCONKIE, 60 EAST SOUTH TEMPLE,, SUITE 1800, SALT LAKE CITY, UT, 84111, US

(73) Assignee: NATIONAL CENTRAL UNIVERSITY, Taoyuan (TW)

(21) Appl. No.: 12/713,961

(22) Filed: Feb. 26, 2010

(30) Foreign Application Priority Data
Feb. 27, 2009 (TW) 098106414

(51) Int. Cl. G11B 7/135

(52) U.S. Cl. 369/112.01; G9B/7.112

(57) ABSTRACT

An optical pickup head includes a first light source, a second light source, a base, a light adjusting unit, and a light guiding unit. The first light source emits a first wavelength light beam to read a first data density optical storage medium. The second light source emits a second wavelength light beam to read a second data density optical storage medium. The base includes at least a slant surface for reflecting the first wavelength light beam and the second wavelength light beam, so that the first wavelength light beam and the second wavelength light beam are parallel with each other. The light adjusting unit adjusts the first wavelength light beam and the second wavelength light beam to the same optical axis. The light guiding unit guides the first wavelength light beam and the second wavelength light beam to the first data density optical storage medium or the second data density optical storage medium.

### FIELD OF THE INVENTION

The present invention relates to an optical pickup head, and more particularly to an optical pickup head for use in an optical storage medium reading apparatus.

### BACKGROUND OF THE INVENTION

An optical storage medium such as a compact disc (CD) or a video compact disc (VCD) is able to store data with a capacity of about 650 MB to 750 MB. When an optical reading apparatus operates, the light beam having a wavelength of about 780 nm is emitted by a laser diode and reflected by an optical disc to a light sensor so as to realize information from the optical disc. With the increasing development of optical storage technologies, the data storage capacity of the optical storage medium is gradually increased. For example, the widely used digital versatile disc (DVD) has a storage capacity of about 4.7 GB, which is about seven times the storage capacity of a compact disc (CD) or a video compact disc (VCD). Recently, a high density digital versatile disc (HD-DVD) has a storage capacity of about 15 GB. As the track pitch of the recording layer of the high capacity optical storage medium is gradually shortened, the data density of the optical storage medium is increased. For reading the optical storage media having various data densities, the optical pickup head of the optical reading apparatus should emit laser light beams with different wavelengths.

FIG. 1 is a schematic view illustrating a laser diode package structure of an optical pickup head with a single laser source according to the prior art. The laser diode package structure 1 comprises a laser diode 101 and a photo-receiver 102, which are disposed on a silicon substrate 100. The laser light beam 103 emitted from the laser diode 101 is reflected by 45-degree slant surface 104 to a lens (not shown) disposed above the laser diode package structure 1. Such laser diode package structure 1 is cost-effective and easily manufactured because the complicated process of assembling the micro-prism is omitted. For reading two different kinds of optical storage media with different data density by an optical reading apparatus (e.g. a DVD player), two laser diodes for emitting light beams with different wavelengths need to be included in two different package structures and two photo-receivers are required to receive the light beams reflected by the optical storage media. Under this circumstance, the possibility of causing undesirable reading error is minimized, but the fabricating cost is increased.

For solving the above drawbacks, Taiwanese Patent No. 245340 has disclosed a laser diode package structure with double-sided 45-degree slant surfaces. FIG. 2 is a schematic view illustrating a laser diode package structure with double-sided 45-degree slant surfaces according to the prior art. As shown in FIG. 2, a silicon substrate 200 is etched to simultaneously define a first holding space 203 and a second holding space 204. Two laser diodes 201 and 202 for emitting light beams with different wavelengths are respectively held in the first holding space 203 and the second holding 204. Each of the first holding space 203 and the second holding space 204 has two 45-degree slant surfaces 205 at bilateral sides thereof. The laser light beams 206 and 207 emitted from the laser diodes 201 and 202 are reflected by the 45-degree slant surfaces 205 to a lens (not shown) disposed above the laser diode package structure 2. During the process of fabricating the laser diode package structure 2, the distance D1 between the first holding space 203 and the second holding space 204 of the silicon substrate 200 is shortened. As such, the distance D2 between the laser light beams 206 and 207 that are emitted from the laser diodes 201 and 202 will be shortened. By using the laser diode package structure 2, a single photo-receiver is required to receive the light beams with two different wavelengths reflected by the optical storage media.

With the increasing development of optical storage technologies, the data storage capacity of the optical storage medium is gradually increased. For reading out the data from the high capacity optical storage medium by the optical pickup head of the optical storage medium reading apparatus, the wavelength of the light beam emitted from the laser diode should be reduced. As shown in FIG. 2, the distance D1 between the first holding space 203 and the second holding space 204 and the distance D2 between the laser light beams 206 and 207 are both shortened during the process of fabricating the laser diode package structure 2. By using the laser diode package structure 2, a single photo-receiver may receive the light beams that are emitted from different laser diodes and reflected by the optical storage medium. As the wavelength of the light beam emitted from the laser diode becomes shorter and shorter for reading out the data from the high capacity optical storage medium, the distance D1 between the first holding space 203 and the second holding space 204 still results in a slight error when the light beams reflected by the optical storage medium are respectively received by the photo-receiver.

FIG. 3 is a schematic view illustrating a laser diode package structure with three laser diodes for emitting laser beams with three different wavelengths according to the prior art. As shown in FIG. 3, the laser diode package structure 3 comprises laser diodes 301, 302 and 303. The laser diodes 301 and 302 are able to read out data from a CD or DVD disc. The laser diode 303 is able to read out data from a HD-DVD disc. Since the laser light beam 308 emitted from the laser diode 303 has a shorter wavelength than the laser light beams 306 and 307 emitted from the laser diodes 301 and 302, two photo-receivers 304 are required to respectively receive the light beams reflected by the optical storage medium. Although the uses of two photo-receivers result in a smaller error when compared with the single photo-receiver, the fabricating cost is increased and the fabricating process is complicated.

### SUMMARY OF THE INVENTION

The present invention provides an optical pickup head for minimizing or eliminating the reading error due to the distance between the two holding spaces of the package structure.

In accordance with an aspect of the present invention, there is provided an optical pickup head for use in an optical storage medium reading apparatus. The optical pickup head includes a first light source, a second light source, a base, a light adjusting unit, and a light guiding unit. The first light source emits a first wavelength light beam to read a first data density optical storage medium. The second light source emits a second wavelength light beam to read a second data density optical storage medium. The base includes a first holding space and a second holding space for holding the first light source and the second light source, respectively. Each of the first holding space and the second holding space has at least a slant surface for reflecting the first wavelength light beam or the second wavelength light beam, so that the first wavelength light beam and the second wavelength light beam reflected by the slant surfaces are parallel with each other. The light adjusting unit is used for receiving the first wavelength light beam and the second wavelength light beam and adjusting the first wavelength light beam and the second wavelength light beam to the same optical axis. The light guiding unit is used for guiding the first wavelength light beam and the second wavelength light beam from the light adjusting unit to the first data density optical storage medium or the second data density optical storage medium.

In accordance with another aspect of the present invention, there is provided an optical pickup head for use in an optical storage medium reading apparatus. The optical pickup head includes a first light source, a second light source, a base, a light adjusting unit, and a light guiding unit. The first light source emits a first wavelength light beam to read a first data density optical storage medium. The second light source emits a second wavelength light beam to read a second data density optical storage medium. The base includes a first holding space and a second holding space for holding the first light source and the second light source, respectively, wherein each of the first holding space and the second holding space has at least a slant surface for reflecting the first wavelength light beam or the second wavelength light beam. The light adjusting unit is used for receiving the first wavelength light beam and the second wavelength light beam and adjusting the first wavelength light beam and the second wavelength light beam to the same optical axis. The light guiding unit is used for guiding the first wavelength light beam and the second wavelength light beam from the light adjusting unit to the first data density optical storage medium or the second data density optical storage medium.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic view illustrating a laser diode package structure of an optical pickup head with a single laser source according to the prior art.

FIG. 2 is a schematic view illustrating a laser diode package structure with double-sided 45-degree slant surfaces according to the prior art;

FIG. 3 is a schematic view illustrating a laser diode package structure with three laser diodes for emitting laser beams with three different wavelengths according to the prior art;

FIG. 4A is a schematic diagram illustrating the optical pickup head according to a first embodiment of the present invention;

FIG. 4B is a functional block diagram illustrating the detailed architecture of the optical pickup head according to the first embodiment of the present invention;

FIG. 4C is a schematic view illustrating the detailed configuration of the light adjusting unit of the optical pickup head according to the first embodiment of the present invention;

FIG. 4D is a schematic exploded view illustrating the prism assembly of the light adjusting unit according to the first embodiment of the present invention;

FIG. 5A is a schematic diagram illustrating the optical pickup head according to a second embodiment of the present invention; and

FIG. 5B is a schematic view illustrating the detailed configuration of the light adjusting unit of the optical pickup head according to the second embodiment of the present invention.

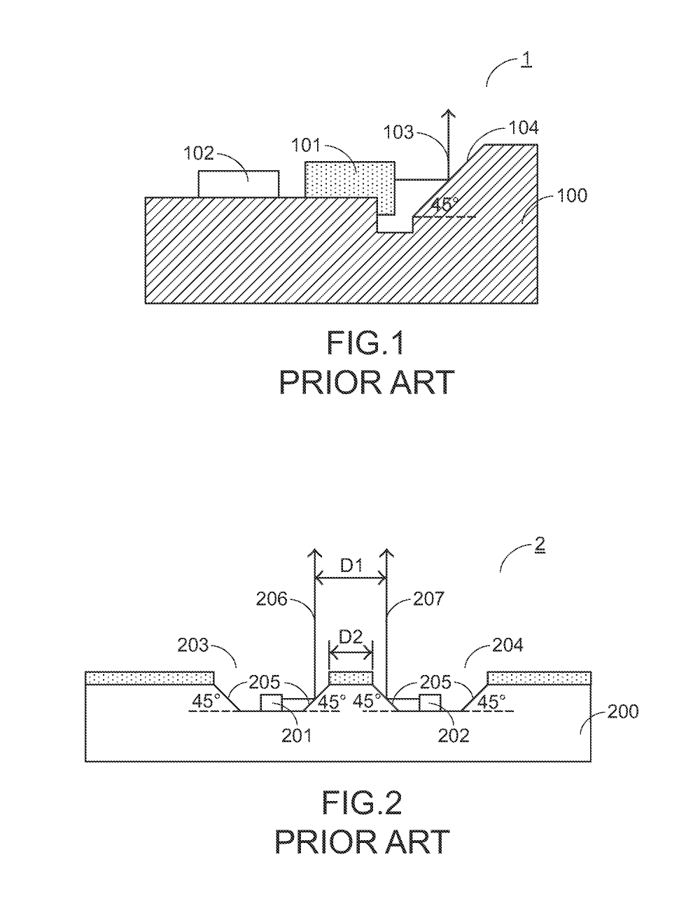

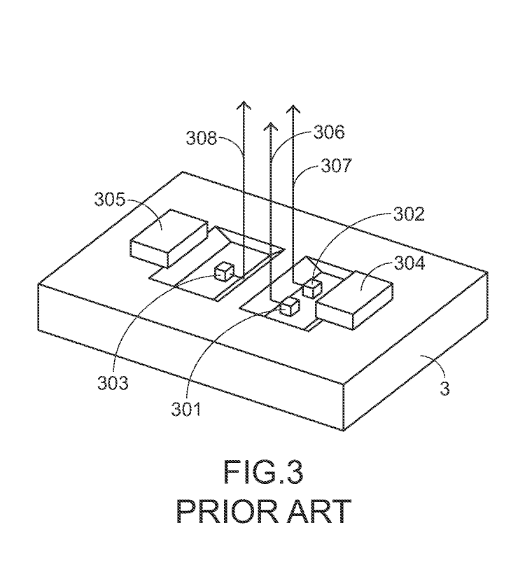

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

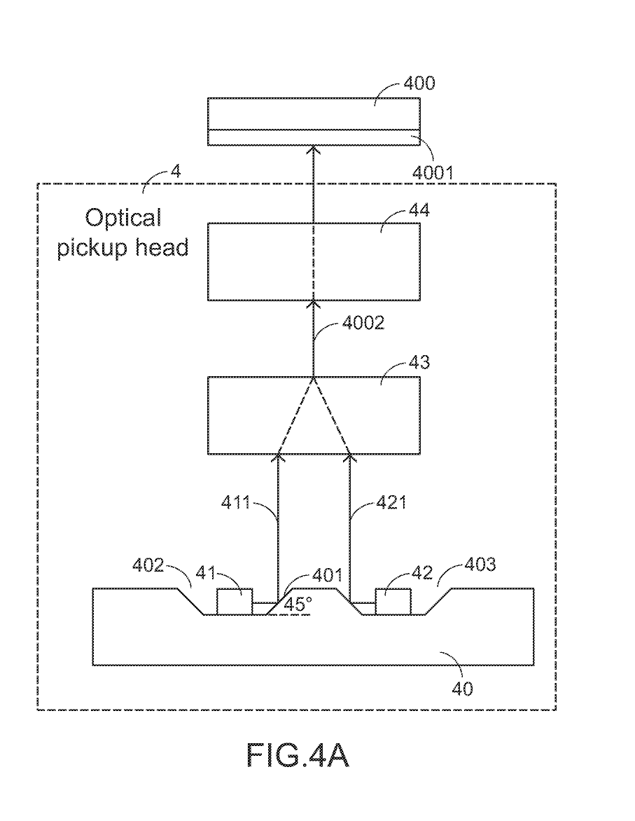

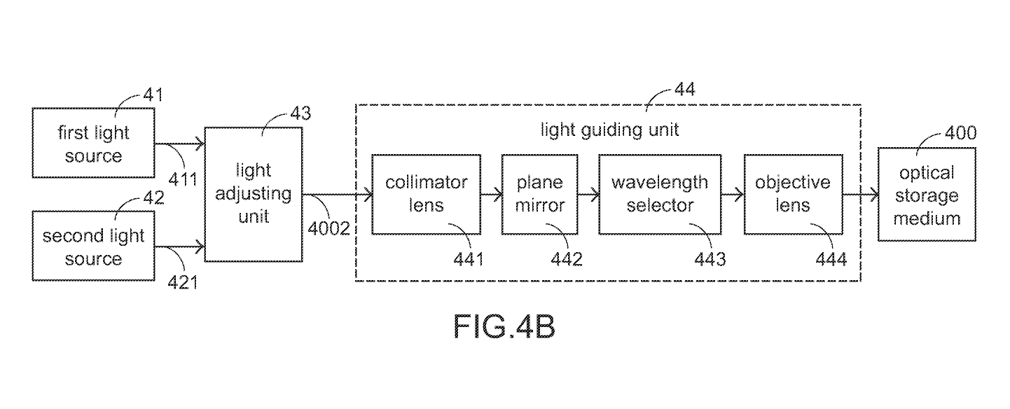

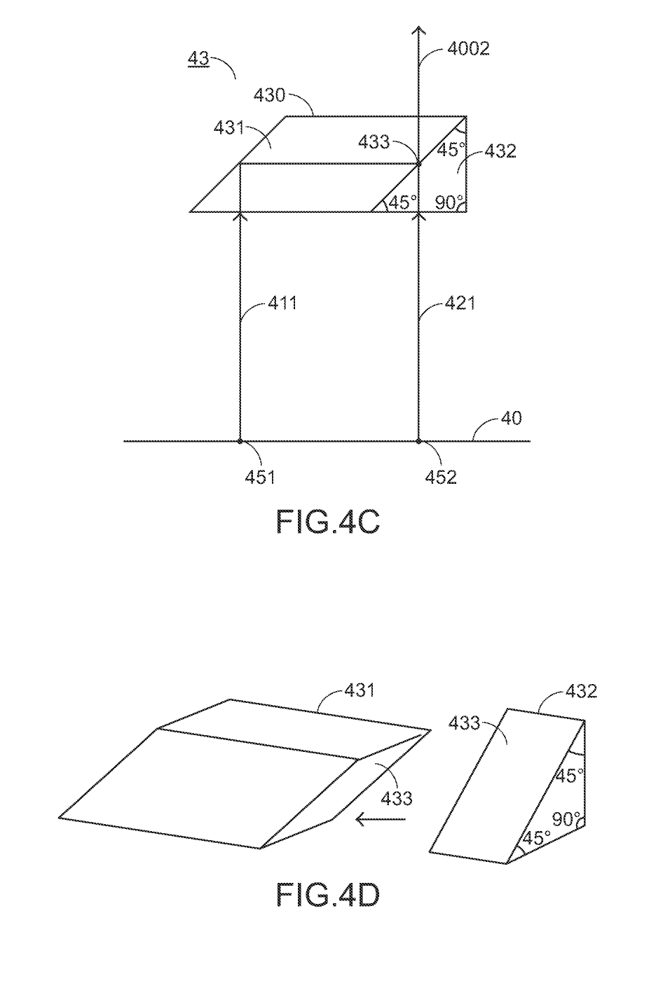

FIGS. 4A, 4B, 4C and 4D schematically illustrating an optical pickup head according to a first embodiment of the present invention. The optical pickup head is mounted in an optical storage medium reading apparatus. An example of the optical storage medium reading apparatus includes but is not limited to an optical disc drive of a computer system, a DVD player, a VCD player.

FIG. 4A is a schematic diagram illustrating the optical pickup head according to the first embodiment of the present invention. As shown in FIG. 4A, the optical pickup head 4 comprises a first light source 41, a second light source 42, a base 40, a light adjusting unit 43 and a light guiding unit 44. The first light source 41 emits a first wavelength light beam 411 for reading an optical storage medium 400 having a first data density (e.g. a compact disc (CD)). The second light source 42 emits a second wavelength light beam 421 for reading another optical storage medium 400 having a second data density (e.g. a digital versatile disc (DVD)). In this embodiment, the first light source 41 and the second light source 42 are laser diodes. The base 40 comprises a first holding space 402 and a second holding space 403. The first light source 41 and the second light source 42 are respectively held in the first holding space 402 and the second holding space 403. The first holding space 402 and the second holding 403 have slant surfaces 401. The first wavelength light beam 411 and the second wavelength light beam 421 respectively emitted from the first light source 41 and the second light source 42 are reflected by the slant surfaces 401, so that the first wavelength light beam 411 and the second wavelength light beam 421 are parallel with each other. In accordance with a key feature of the present invention, the light adjusting unit 43 is included in the optical pickup head 4. When the first wavelength light beam 411 or the second wavelength light beam 421 is received by the light adjusting unit 43, the light adjusting unit 43 will adjust the first wavelength light beam 411 and the second wavelength light beam 421 to move along the same optical axis 4002. After adjusted by the light adjusting unit 43, the first light source 41 and the second light source 42 are directed to the light guiding unit 44. By the light guiding unit 44, the first light source 41 and the second light source 42 are guided to the recording layer 4001 of the optical storage medium 400 having the first data density or the second data density.

FIG. 4B is a functional block diagram illustrating the detailed architecture of the optical pickup head according to the first embodiment of the present invention. As shown in FIG. 4B, the light guiding unit 44 comprises a collimator lens 441, a plane mirror 442, a wavelength selector 443 and an objective lens 444. When the first wavelength light beam 411 and the second wavelength light beam 421 are received by the collimator lens 441, the angles of the first wavelength light beam 411 and the second wavelength light beam 421 are adjusted such that the first wavelength light beam 411 and the second wavelength light beam 421 are collimated into parallel light beams. By the plane mirror 442, the optical paths of the collimated first wavelength light beam 411 and the collimated second wavelength light beam 421 are changed. The aperture size of the wavelength selector 443 is changed for allowing the first wavelength light beam 411 or the second wavelength light beam 421 to pass therethrough. The first wavelength light beam 411 or the second wavelength light beam 421 that is outputted from the wavelength selector 443 is focused by the objective lens 444, and the focused first wavelength light beam 411 or the focused second wavelength light beam 421 is directed to the optical storage medium 400 having the first data density or the second data density to read out data from the recording layer 4001 of the optical storage medium 400. In accordance with a key feature of the present invention, before the first wavelength light beam 411 or the second wavelength light beam 421 is directed to the light guiding unit 44, the optical paths of the first wavelength light beam 411 and the second wavelength light beam 421 are adjusted by the light adjusting unit 43 such that the first wavelength light beam 411 and the second wavelength light beam 421 move along the same optical axis 4002.

FIG. 4C is a schematic view illustrating the detailed configuration of the light adjusting unit of the optical pickup head according to the first embodiment of the present invention. As shown in FIG. 4C, the first wavelength light beam 411 is emitted from a first position 451 of the base 40, and the second wavelength light beam 421 is emitted from a second position 452 of the base 40. In this embodiment, the light adjusting unit 43 includes a prism assembly 430. By the prism assembly 430 of the light adjusting unit 43, the light beams 411 and 421 that are emitted from different positions 451 and 452 of the base 40 and have different wavelength are adjusted. As such, the first wavelength light beam 411 emitted from the first position 451 of the base 40 and the second wavelength light beam 421 emitted from the second position 452 of the base 40 move along the same optical axis 4002. The prism assembly 430 comprises a parallelepiped prism 431 and a 45-90-45 degree triangular prism 432. The parallelepiped prism 431 and the triangular prism 432 are jointed together, wherein a beam-splitting film is formed on the jointing surface 433 between the parallelepiped prism 431 and the triangular prism 432. FIG. 4D is a schematic exploded view illustrating the parallelepiped prism 431 and the triangular prism 432 of the prism assembly 430 of the light adjusting unit 43. Please refer to FIG. 4C again. When the first wavelength light beam 411 is directed to the prism assembly 430, the first wavelength light beam 411 is reflected by one side of the parallelepiped prism 431 and the beam-splitting film on the jointing surface 433 so as to leave the prism assembly 430 along the optical axis 4002. Whereas, when the second wavelength light beam 421 is directed to the prism assembly 430, the second wavelength light beam 421 is permitted to be transmitted through the beam-splitting film on the jointing surface 433 so as to leave the prism assembly 430 along the same optical axis 4002. In other words, by the light adjusting unit 43, the first wavelength light beam 411 and the second wavelength light beam 421 are adjusted to move along the same optical axis 4002.

From the above description, the use of the light adjusting unit in the optical pickup head of the present invention is capable of adjusting the first wavelength light beam and the second wavelength light beam to move along the same optical axis. As a consequence, when the light beams reflected by the optical storage media are received by the photo-receiver, the reading error due to the distance between the two light sources of the package structure will be minimized or eliminated.

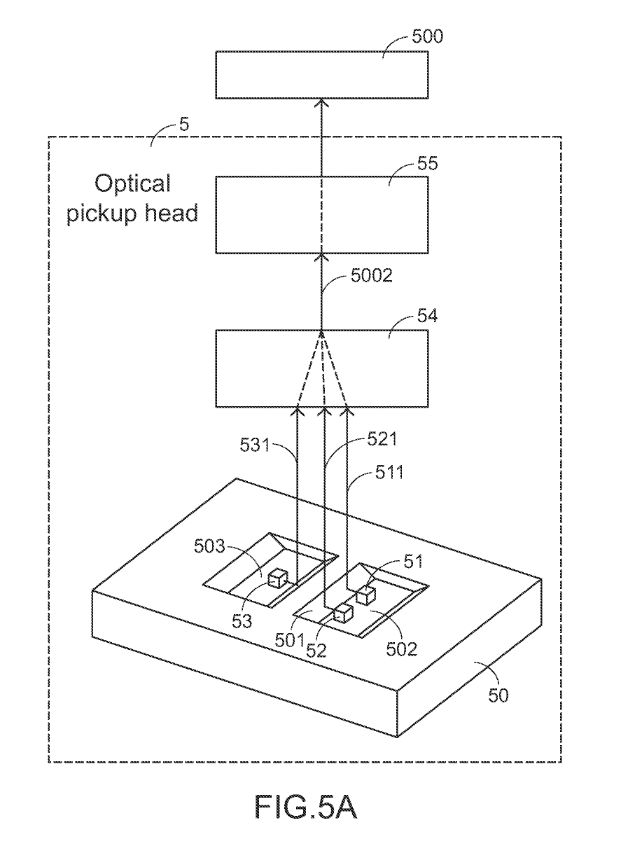

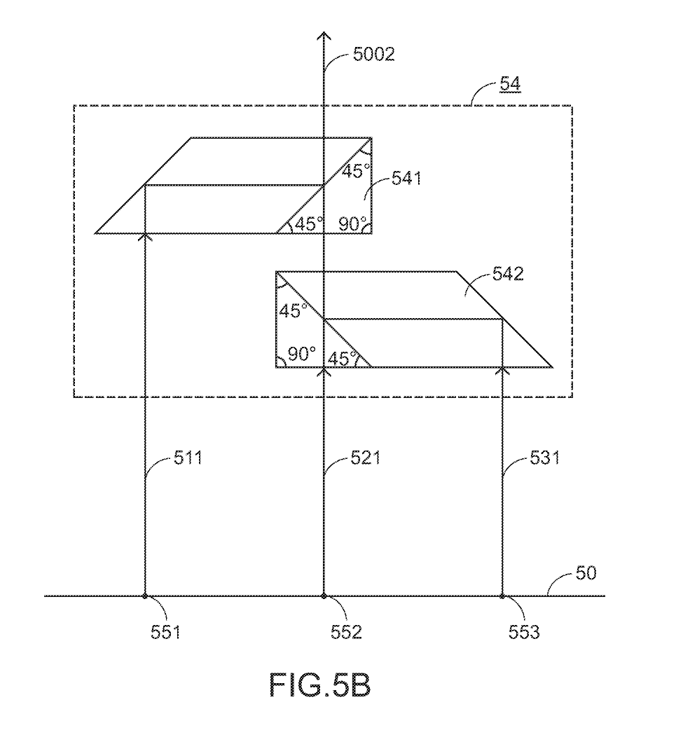

FIG. 5A is a schematic diagram illustrating the optical pickup head according to a second embodiment of the present invention. As shown in FIG. 5A, the optical pickup head 5 comprises a first light source 51, a second light source 52, a third light source 53, a base 50, a light adjusting unit 54 and a light guiding unit 55. The first light source 51 emits a first wavelength light beam 511 for reading an optical storage medium 500 having a first data density (e.g. a compact disc (CD)). The second light source 52 emits a second wavelength light beam 521 for reading another optical storage medium 500 having a second data density (e.g. a digital versatile disc (DVD)). The third light source 53 emits a third wavelength light beam 531 for reading another optical storage medium 500 having a third data density (e.g. a HD-DVD disc). The base 50 comprises a first holding space 502 and a second holding 503. The first light source 51 and the second light source 52 are held in the first holding space 502. The third light source 53 is held in the second holding pace 503. The first holding space 502 and the second holding space 503 have slant surfaces 501. The first wavelength light beam 511, the second wavelength light beam 521 and the third wavelength light beam 531 respectively emitted from the first light source 51, the second light source 52 and the third light source 53 are reflected by the slant surfaces 501, so that the first wavelength light beam 511, the second wavelength light beam 521 and the third wavelength light beam 531 are parallel with each other. When the first wavelength light beam 511, the second wavelength light beam 521 or the third wavelength light beam 531 is received by the light adjusting unit 54, the light adjusting unit 54 will adjust the first wavelength light beam 511, the second wavelength light beam 521 and the third wavelength light beam 531 to move along the same optical axis 5002. The configurations and functions of the light guiding unit 55 are similar to those illustrated in the first embodiment, and are not redundantly described herein.

FIG. 5B is a schematic view illustrating the detailed configuration of the light adjusting unit of the optical pickup head according to the second embodiment of the present invention. As shown in FIG. 5B, the first wavelength light beam 511 is emitted from a first position 551 of the base 50, the second wavelength light beam 521 is emitted from a second position 552 of the base 50, and the third wavelength light beam 531 is emitted from a third position 553 of the base 50. In comparison with the first embodiment, the optical pickup head 5 further includes the third light source 53 for emitting a third wavelength light beam 531 to read the optical storage medium 500 having a third data density. In other words, the package structure of the optical pickup head 5 comprises three laser diodes for emitting light beams with different wavelengths. Similarly, by the light adjusting unit 54, the light beams 511, 521 and 531 that are emitted from different positions 551, 552 and 553 of the base 50 and have different wavelength are adjusted. In this embodiment, the light adjusting unit 54 comprises a first prism assembly 541 and a second prism assembly 542. By the first prism assembly 541 and the second prism assembly 542 of the light adjusting unit 54, the first wavelength light beam 511, the second wavelength light beam 521 and the third wavelength light beam 531 emitted from different positions 551, 552 and 553 of the base 50 are adjusted to move along the same optical axis 5002. The configurations and functions of the first prism assembly 541 and the second prism assembly 542 are similar to those of the prism assembly 430 shown in FIG. 4C, and are not redundantly described herein. The operation principles of adjusting the first wavelength light beam 511, the second wavelength light beam 521 and the third wavelength light beam 531 are also similar to those illustrated in the first embodiment, and are not redundantly described herein.

From the above description, the optical pickup head of the present invention has the light adjusting unit to adjust the light beams that are emitted from different positions of the base to move along the same optical axis. When the light beams reflected by the optical storage media are received, the reading error due to the distance between the two holding spaces of the package structure will be minimized or eliminated.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical pickup head for use in an optical storage medium reading apparatus, the optical pickup head comprising:
a first light source for emitting a first wavelength light beam to read a first data density optical storage medium;
a second light source for emitting a second wavelength light beam to read a second data density optical storage medium;
a base comprising a first holding space and a second holding space for holding the first light source and the second light source, respectively, wherein each of the first holding space and the second holding space has at least a slant surface for reflecting the first wavelength light beam or the second wavelength light beam, so that the first wavelength light beam and the second wavelength light beam reflected by the slant surfaces are parallel with each other;
a light adjusting unit for receiving the first wavelength light beam and the second wavelength light beam and adjusting the first wavelength light beam and the second wavelength light beam to the same optical axis; and
a light guiding unit for guiding the first wavelength light beam and the second wavelength light beam from the light adjusting unit to the first data density optical storage medium or the second data density optical storage medium.

2. The optical pickup head according to claim 1 wherein the light adjusting unit comprises a prism assembly, which reflects the first wavelength light beam and transmits the second wavelength light beam, respectively, so that the first wavelength light beam and the second wavelength light beam are adjusted to the same optical axis.

3. The optical pickup head according to claim 2 wherein the prism assembly comprises a parallelepiped prism and a 45-90-45 degree triangular prism, and a beam-splitting film is formed on a jointing surface between the parallelepiped prism and the 45-90-45 degree triangular prism.

4. The optical pickup head according to claim 1, further comprising a third light source for emitting a third wavelength light beam to read a third data density optical storage medium, wherein the third wavelength light beam is further adjusted by the light adjusting unit to move along the same optical axis as the first wavelength light beam and the second wavelength light beam.

5. The optical pickup head according to claim 4 wherein the first light source, the second light source and the third light source are laser diodes.

6. The optical pickup head according to claim 4 wherein the base further comprises a third holding space for holding the third light source, and the third holding space has an additional slant surface for reflecting the third wavelength light beam, so that the third wavelength light beam is parallel with the first wavelength light beam and the second wavelength light beam.

7. The optical pickup head according to claim 4 wherein the first data density optical storage medium is a compact disc, the second data density optical storage medium is a digital versatile disc, and the third data density optical storage medium is a high density digital versatile disc.

8. The optical pickup head according to claim 4 wherein the light adjusting unit comprises a first prism assembly and a second prism assembly for adjusting the first wavelength light beam, the second wavelength light beam and the third wavelength light beam to move along the same optical axis.

9. The optical pickup head according to claim 8 wherein each of the first prism assembly and the second prism assembly comprises a parallelepiped prism and a 45-90-45 degree triangular prism, and a beam-splitting film is formed on a jointing surface between the parallelepiped prism and the 45-90-45 degree triangular prism.

10. The optical pickup head according to claim 1 wherein the light guiding unit comprises:
a collimator lens for adjusting angles of the first wavelength light beam and the second wavelength light beam such that the first wavelength light beam and the second wavelength light beam are collimated into parallel light beams;
a plane mirror for changing optical paths of the collimated first wavelength light beam and the collimated second wavelength light beam;
a wavelength selector for allowing the first wavelength light beam or the second wavelength light beam to penetrate through a changeable aperture size; and
an objective lens for focusing the first wavelength light beam or the second wavelength light beam that is outputted from the wavelength selector, so that the first data density optical storage medium is read by the first wavelength light beam or the second data density optical storage medium is read by the second wavelength light beam.

11. An optical pickup head for use in an optical storage medium reading apparatus, the optical pickup head comprising:
a first light source for emitting a first wavelength light beam to read a first data density optical storage medium;
a second light source for emitting a second wavelength light beam to read a second data density optical storage medium;
a base comprising a first holding space and a second holding space for holding the first light source and the second light source, respectively, wherein each of the first holding space and the second holding space has at least a slant surface for reflecting the first wavelength light beam or the second wavelength light beam;
a light adjusting unit for receiving the first wavelength light beam and the second wavelength light beam and adjusting the first wavelength light beam and the second wavelength light beam to the same optical axis; and
a light guiding unit for guiding the first wavelength light beam and the second wavelength light beam from the light adjusting unit to the first data density optical storage medium or the second data density optical storage medium.

12. The optical pickup head according to claim 11 wherein the light adjusting unit comprises a prism assembly which reflects the first wavelength light beam and transmits the second wavelength light beam, respectively, so that the first wavelength light beam and the second wavelength light beam are adjusted to the same optical axis.

13. The optical pickup head according to claim 12 wherein the prism assembly comprises a parallelepiped prism and a 45-90-45 degree triangular prism, and a beam-splitting film is formed on a jointing surface between the parallelepiped prism and the 45-90-45 degree triangular prism.

14. The optical pickup head according to claim 11, further comprising a third light source for emitting a third wavelength light beam to read a third data density optical storage medium, wherein the third wavelength light beam is further adjusted by the light adjusting unit to move along the same optical axis as the first wavelength light beam and the second wavelength light beam.

15. The optical pickup head according to claim 14 wherein the first light source, the second light source and the third light source are laser diodes.

16. The optical pickup head according to claim 14 wherein the base further comprises a third holding space for holding the third light source, and the third holding space has an additional slant surface for reflecting the third wavelength light beam, so that the third wavelength light beam is parallel with the first wavelength light beam and the second wavelength light beam.

17. The optical pickup head according to claim 14 wherein the first data density optical storage medium is a compact disc, the second data density optical storage medium is a digital versatile disc, and the third data density optical storage medium is a high density digital versatile disc.

18. The optical pickup head according to claim 14 wherein the light adjusting unit comprises a first prism assembly and a second prism assembly for adjusting the first wavelength light beam, the second wavelength light beam and the third wavelength light beam to move along the same optical axis.

19. The optical pickup head according to claim 18 wherein each of the first prism assembly and the second prism assembly comprises a parallelepiped prism and a 45-90-45 degree triangular prism, and a beam-splitting film is formed on a jointing surface between the parallelepiped prism and the 45-90-45 degree triangular prism.

20. The optical pickup head according to claim 11 wherein the light guiding unit comprises:
a collimator lens for adjusting angles of the first wavelength light beam and the second wavelength light beam such that the first wavelength light beam and the second wavelength light beam are collimated into parallel light beams;
a plane mirror for changing optical paths of the collimated first wavelength light beam and the collimated second wavelength light beam;
a wavelength selector for allowing the first wavelength light beam or the second wavelength light beam to penetrate through a changeable aperture size; and
an objective lens for focusing the first wavelength light beam or the second wavelength light beam that is outputted from the wavelength selector, so that the first data density optical storage medium is read by the first wavelength light beam or the second data density optical storage medium is read by the second wavelength light beam.
